(19) United States
(12) Patent Application Publication
(10) Pub. No.: US 2011/0023920 A1
(43) Pub. Date: Feb. 3, 2011

(54) DIGITAL WALKER

(76) Inventor: Robert Bolton, Baton Rouge, LA (US)

Correspondence Address: KEAN, MILLER, HAWTHORNE, D'ARMOND,;MCCOWAN & JARMAN, L.L.P., ONE AMERICAN PLACE, 22ND FLOOR, P.O. BOX 3513, BATON ROUGE, LA, 70821, US

(21) Appl. No.: 12/833,779

(22) Filed: Jul. 9, 2010

Related U.S. Application Data
(60) Provisional application No. 61/224,550, filed on Jul. 10, 2009.

(51) Int. Cl. A61H 3/00

(52) U.S. Cl. 135/66

(57) ABSTRACT

A digital walker comprising a walker with a digital monitoring device and digital display are described herein. The digital monitoring device comprises at least one sensor. The sensor may be a biological or physiological sensor, a geographical or distance sensor, or a speed sensor. The data from the sensor may be displayed on the digital display.

### CROSS REFERENCE TO RELATED APPLICATIONS

This application claims priority to the provisional U.S. patent application No. 61/224,550 entitled “Digital Walker,” filed Jul. 10, 2009.

### STATEMENT REGARDING FEDERALLY SPONSORED RESEARCH OR DEVELOPMENT

Not Applicable.

### REFERENCE TO A “SEQUENCE LISTING,” A TABLE, OR A COMPUTER PROGRAM

Not Applicable.

### DESCRIPTION OF THE DRAWINGS

FIG. 1 is a depiction of one embodiment of a three-legged walker with a mounted digital monitor and digital display.

FIG. 2 is a depiction of one embodiment of a four-legged walker with a mounted digital monitor and display.

FIG. 3 is a depiction of one embodiment of a digital monitor and digital display.

FIG. 4 is a depiction of another embodiment of a digital monitor and digital display.

FIG. 5 is another embodiment of a four-legged walker with a mounted digital monitor and digital display.

### DETAILED DESCRIPTION

A walker with a digital monitor is described herein. The walker has at least three legs. In a three legged walker, there is one front leg and two back legs. The walker has at least one wheel at the bottom end of the front leg. The walker may have wheels on the back legs as well. If the walker has four legs, the front two legs have wheels located at the bottom ends of the front legs. Also, the back legs may have wheels located at the bottom thereof. The wheel(s) contacts a surface and rolls thereon. In one embodiment, the walker may have two handles or alternatively two handgrips. The handles or handgrips are gripped by a user. In another embodiment, the walker may have a storage container, such as a basket, to hold physical objects.

The walker also has a digital monitor, with a digital display. In one embodiment, the digital monitor displays information biological information and/or physiological information about the user, such as, but not limited to, the heart rate of the user, blood oxygen saturation levels, or caloric output, which is obtained from sensors in communication with the digital monitor. In another embodiment, the digital monitor displays geographical information, such as, but not limited to, distance traveled, current location, or distance left to be traveled, which is obtained from sensors in communication with the digital monitor. In one embodiment, the biological, physiological and/or geographical information may be displayed on the digital display. In yet another embodiment, the walker may have an electronic storage device to store the biological, physiological and/or geographical information collected from the sensors.

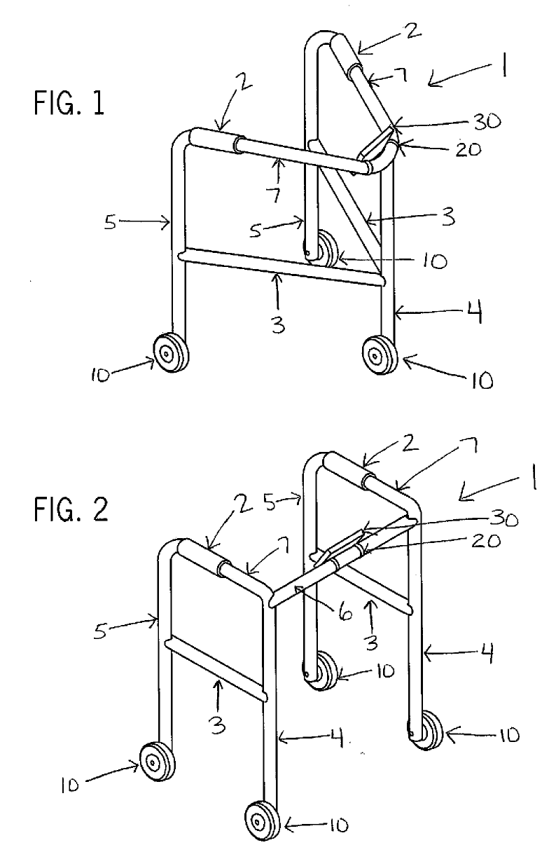

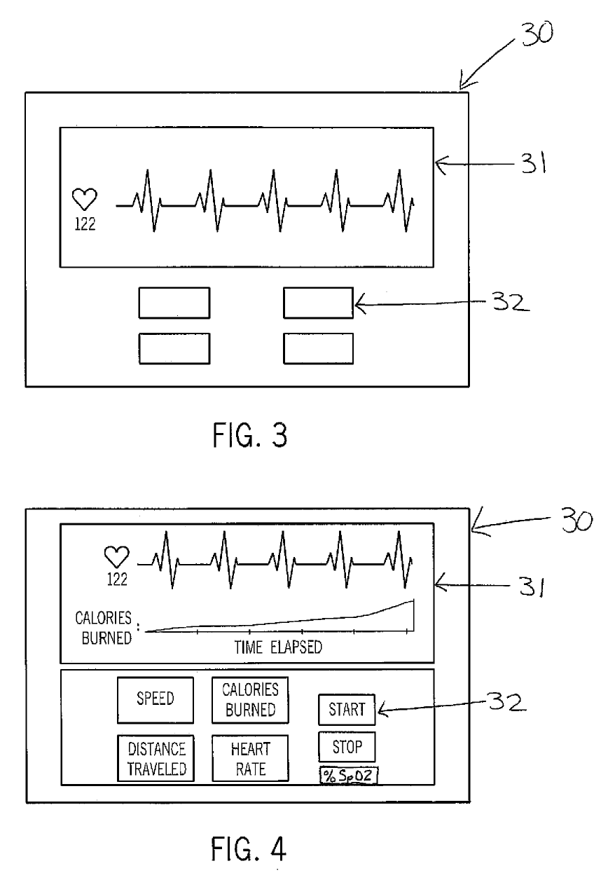

Three Legged Walker. With reference to FIG. 1, in one embodiment, the walker (1), has a frame with three legs and comprises a front leg (4), and two side upper braces (7), each side upper brace (7) connected to a rear leg (5). The side upper braces (7) are connected to the front of the frame. In one embodiment, the side upper braces (7) are substantially parallel and are each connected to a front bar (not shown). In an alternate embodiment, the side upper braces (7) are connected to each other at the front of the frame. In another embodiment, the side upper braces (7) are angled outward from each other, such that there is more distance between the two rear legs (5) of the side upper braces (7) than between the front of the side upper braces (7). The side upper braces (7) each have a front end and a back end. The front end of each side upper brace (7) connects to the front bar (not shown) or, alternatively, to each other to each other (as shown in FIG. 1), while the rear end projects away from the front of the frame. Each side upper brace (7) has a rear leg (5) located at the back end of the side upper brace (7). The rear leg (5) of each side upper brace (7) has a top end and a bottom end. The top end is positioned farthest from the ground and the bottom end is positioned closest to the ground. In one embodiment, the rear leg (5) of each side upper brace (7) is connected to the front leg (4) by at least the side upper brace (7) located adjacent to the top end of the rear legs (5). In an alternate embodiment, the front leg (4) and rear legs (5) are connected by at least one side lower brace (3). The side lower brace (3) may be located at any position along the front leg (4) and rear legs (5). In one embodiment, the side lower brace (3) is substantially parallel to the side upper brace (7). In another embodiment, the side lower brace (3) connects to the front leg (4) and rear legs (5) such that the angle at the two connection points is not ninety degrees. In yet another embodiment, there are multiple lower braces (3) located below the side upper braces (7).

In one embodiment, the front of the frame has a front upper brace (not shown). The front upper brace may be positioned so that it is at the same level as the two side upper braces (7). In an alternate embodiment, the front upper brace is positioned below the two side upper braces (7). In another embodiment, the front upper brace is positioned above the side upper braces (7). The front upper brace is substantially parallel to the ground. In yet another embodiment, the two side upper braces (7) will be connected to the front upper brace and a front lower brace (not shown). The front lower brace being connected to the rear legs (5) such that it is positioned below the front upper brace. In one embodiment, the front upper brace is substantially straight. In another embodiment the front brace is curved, either towards the user or away from the user. In yet another embodiment, the front brace is angled, either towards the user or away from the user. Likewise, the lower brace may be straight, curved, or angled.

The front leg (4) of the walker (1) is located at the front of the frame. The front leg (4) has an upper end and a bottom end. In one embodiment, the upper end of the front leg (4) is connected to the front of the frame at the front upper brace, equidistance between the two side upper braces (7). In another embodiment, the upper end of the front leg (4) is connected to the front of the frame at the front lower brace, equidistance between the two side upper braces (7). In yet another embodiment, the upper end of the front leg (4) is connected to the front of the frame at the front upper brace and the front leg (4) is also connected to the front frame at the front lower brace. In still another embodiment, the front leg (4) is connected to the side upper braces (7). In yet a further embodiment, the front leg (4) is connected to the side upper braces (7) and the side lower braces (3).

In one embodiment, a gripping surface (2) is located on each side upper brace (7). The gripping surface (2) may be located at any position along the side upper brace (7). In another embodiment, the gripping surface (2) makes up the entire side upper brace (7). In yet another embodiment, the gripping surface comprises hand grips (not shown) and are located on side bars (not shown) connected to the front upper brace. The side bars may be straight, curved, or angular. In one embodiment, the side bars are aligned such that they are planar with the side upper braces (7). In another embodiment, the side bars are aligned such that they are more narrowly spaced than the side upper braces (7). In yet a further embodiment, the hand grips are connected to the side upper braces (7). Gripping surfaces and hand grips come in many types and sizes and are known in the art.

In another embodiment, there is a frame with a front leg (4) connected as described above. The frame has at least one brace, the front upper brace. The upper end of the front leg (4) is connected to the front upper brace, equidistance between the sides of the front upper brace. In one embodiment, the frame has a front upper brace and a front lower brace. The upper end of the front leg (4) may be connected to either the front upper brace or the front lower brace such that the front leg (4) is equidistance between each side of either the front upper brace or the front lower brace. In yet another embodiment, the upper end of the front leg (4) is connected to the front upper brace and the front leg (4) is also connected to the front lower brace. The front leg (4) is angled away from the front upper brace such that the angle between the front upper brace and the front leg (4) is not ninety degrees. In one embodiment (not shown), there are two rear legs (5), each having a top end and bottom end. The top end of each rear leg (5) is connected to the front upper brace, such that there is one rear leg (5) attached to each end of the front upper brace. In another embodiment (not shown), the top end of each rear leg (5) is connected to the front lower brace. In this embodiment, the two rear legs (5) extend back away from the front leg (4), such that the angle between either the front upper brace or the front lower brace and each rear leg (5) is not ninety degrees. Two side bars extend up from each side of the front upper brace. In one embodiment, the side bars are planar with the rear legs (5). In another embodiment, the side bars are narrower than the rear legs (5). The side bars may be straight, curved, or angular. The side bars have hand grips (2) located thereon. The handgrips (2) may be located at any position on the side bars.

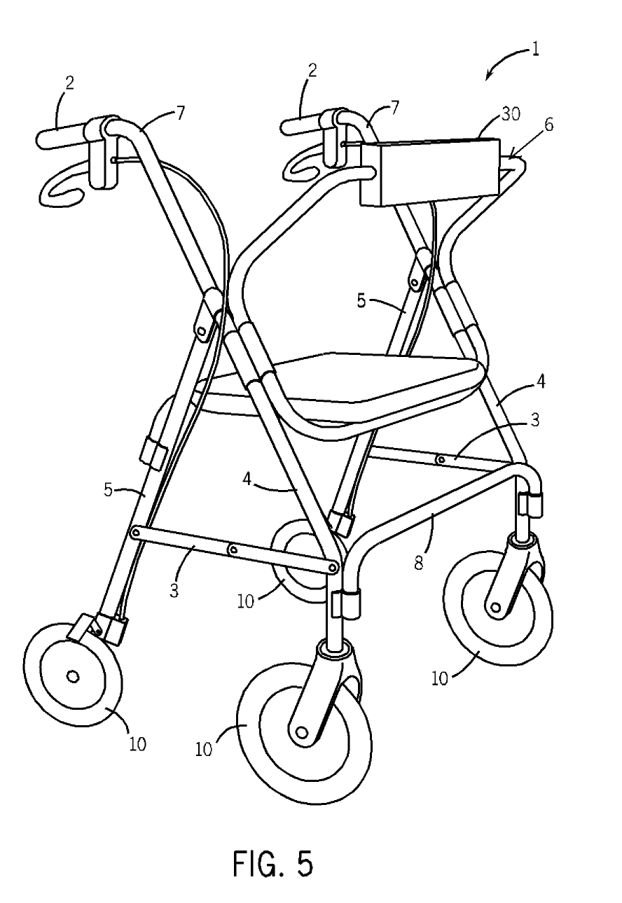

Four Legged Walker. With reference to FIGS. 2 and 5, the four legged walker (1) consists of two side frames, each side frame having a front leg (4) and a rear leg (5). The two side frames are connected with one another by at least one front brace. The front legs (4) and rear legs (5) of the side frames all have a top end and a bottom end. The top end is positioned farthest from the ground and the bottom end is positioned closest to the ground. In one embodiment, the side frames are substantially parallel. In an alternate embodiment, the side frames are not parallel. Instead the front sections of the side frames are closer together than the back sections of the two side frames. The front legs (4) and rear legs (5) of the side frame are connected by at least one side upper brace (7) located at the top end of the legs. In one embodiment, the side upper braces (7) are substantially parallel to the ground, as shown in FIG. 2. In an alternate embodiment, the side upper braces (7) are not substantially parallel to the ground, as shown in FIG. 5. The side upper brace (7) has a gripping surface (2). In an alternate embodiment, the front legs (4) and rear legs (5) are also connected by at least one side lower brace (3). The side lower brace (3) may be located at any position along the front legs (4) and rear legs (5). In one embodiment, the side lower brace (3) is substantially parallel to the side upper brace (7). In another embodiment, the side lower brace (3) connects to the front legs (4) and rear legs (5) such that the angle at the two connection points is not ninety degrees. In yet another embodiment, there are multiple side braces located below the side upper brace (7).

The two front legs (4) of the side frames are connected by a front upper brace (6). The front upper brace (6) may be positioned so that it is at the same level as the two side upper braces (7) on the side frames. In an alternate embodiment, the front upper brace (6) is positioned below the side upper brace (7) on the two side frames. The front upper brace (6) is substantially parallel to the ground. In yet another embodiment, the two front legs (4) will be connected by both a front upper brace (6) and a front lower brace (8). The front lower brace (8) being connected to the two front legs (4) of the side frames such that it is positioned below the front upper brace (6).

The three-legged embodiments and four-legged embodiments may also be foldable. Additionally, the three-legged embodiment and four-legged embodiments may be adjustable so that the total height of the walker may be either raised or lowered depending on the height of the user.

In one embodiment, a gripping surface (2) is located on each side upper brace (7). The gripping surface (2) may be located at any position along the side upper brace (7). In another embodiment, the gripping surface (2) makes up the entire side upper brace (7). In yet another embodiment, the gripping surface comprises hand grips, as shown in FIG. 5). In another embodiment, the gripping surface comprises hand grips which are located on side bars (not shown) connected to the front upper brace. The side bars may be straight, curved, or angular. In one embodiment, the side bars are aligned such that they are planar with the side upper braces (7). In another embodiment, the side bars are aligned such that they are more narrowly spaced than the side upper braces (7). In yet a further embodiment, the hand grips are connected to the side upper braces (7).

Wheels. Wheels (10) may be spring loaded or biased so that when the walker is not in use, the feet (or foot if the walker has only three legs) of the walker's front leg/legs are lifted slightly off the ground. In one embodiment, the leg or legs with wheels have a wheel axle located at the bottom end of the leg. The wheel (10) or wheels for that leg are removably attached to the wheel axle. In an alternate embodiment, the wheel(s) (10) are permanently attached to the wheel axle.

A walker having three legs has a single leg in the front (4) and two back legs (5). The front leg (4) will be positioned equidistance between the two back legs (5). If there is one wheel (10), the wheel (10) will be on the bottom end of the front leg (4). Alternatively, all three legs may have at least one wheel (10) positioned at the bottom thereof. In another embodiment, all three legs have wheels (10) located at the bottom end of each leg and at least one leg has two wheels.

In one embodiment of the four-legged walker, each of the front legs (4) have wheels (10) at the bottom thereof while the two rear legs (5) do not have wheels. Alternatively, all four legs of the four-legged walker may have wheel(s) (10) positioned at the bottom ends thereof. In yet a further embodiment, the legs may have two wheels (10) attached to the bottom thereof.

Storage Container. Any of the embodiments described herein may also have a storage container, such as a basket, which is connected to the front frame, front upper brace, or front lower brace. The storage container may be made of materials, including but not limited to, canvas, cloth, mesh, plastic, metal, aluminum, or any other material known in the art. In one embodiment, the storage container is permanently attached, such as by welding or by being integrally formed with the front frame, front upper brace, or front lower brace. In another embodiment, the storage device is removably attached to the front frame, front upper brace, or front lower brace, such as by connections with screws and bolts, snaps, ties, Velcro, etc.

Digital Monitoring/Sensing System. A microprocessor subsystem controls the digital monitoring/sensing system. The microprocessor subsystem is connected to a user interface, a display, and at least one sensor. A power supply, e.g., a battery, provides power to the microprocessor subsystem. In one embodiment, the power supply is connected to the user interface, display, speed sensor, and/or distance sensors, biomedical or physiological response sensors, geographical sensors and a calculating unit via appropriate electrical interconnections. In another embodiment, the digital monitoring system (30) comprises at least one of the following: a speed sensor, a distance sensor, and a biomedical and/or physiological response sensor. In an alternate embodiment, the digital monitoring system (30) also comprises a calculating unit. In one embodiment the microprocessor subsystem includes memory for storing data acquired by the system. In another embodiment, an external memory device stores data obtained from the sensors. In yet another embodiment, the external memory device stores information input by the user. In an alternate embodiment, the data may be uploaded to a computer or other device through means known in the art.

The microprocessor subsystem is incorporated into a housing. In one embodiment, the housing is constructed so that it protects the user interface, display, and speed sensor from the elements of nature, such as, but not limited to, rain, snow, sand, and dust. The housing is attachable to walker. In one embodiment, the housing is attached to the front upper brace (6) of the walker. In another embodiment, the housing is removably attached to the front upper brace (6) by means (20) known in the art, such as, but not limited to, screws, Velcro, snaps, bolts, fasteners, clamps, etc. In another embodiment, the housing is permanently attached to the front upper brace (6) by means known in the art, such as, but not limited to, welding, glue, etc. In yet another embodiment, the housing is integrally formed with the front upper brace (6). The housing is connected or mounted to the front upper brace (6) such that the user can access the system.

The sensor or sensors are in communication with the microprocessor system. In one embodiment, the sensors may send information over a communication line to the microprocessor subsystem. In another embodiment, the sensors wirelessly communicate with the microprocessor subsystem. The information is processed by the microprocessor subsystem to quantify the information and display and/or store the information. In one embodiment, the microprocessor subsystem utilizes data from the speed sensor to quantify actual speed, e.g. in miles per hour. In an alternate embodiment, the microprocessor subsystem utilizes data from the biomedical response sensor to quantify data such as heart beats per minute, blood oxygen saturation levels, and/or whether the user is within a minimum or maximum heart rate goal. In yet another embodiment, the microprocessor subsystem quantifies data obtained from the distance or geographical sensor to information such as determine distance traveled, distance remaining, distance traveled over a time period, such as daily, weekly, or monthly. In another embodiment, the microprocessor subsystem utilizes information obtained from the calculating unit to determine caloric expenditure, caloric expenditure remaining, and caloric expenditure over a period of time, such as daily, weekly, or monthly. Sensors of the type described above are known in the art.

After obtaining the data, the microprocessor then stores the quantified data in either internal or external memory. Upon access through the user interface, which communicates with the microprocessor subsystem either wirelessly or through a communication line, a user of the system can command the display of the data on the display. If more than one sensor is included, then the digital display (31) may display information from either just one sensor, or from multiple sensors simultaneously.

In an alternate embodiment, the data received from the sensors may be stored prior to processing by the microprocessor subsystem. The data is then quantified for display on the digital display (31) when commanded by a user of the system.

In one embodiment, during motion of the walker, a speed sensor sends velocity information to the microprocessor subsystem. There are many types of speed sensors such as laser and GPS based speed sensors. Examples of some speed sensors are disclosed in U.S. Pat. No. 7,054,784.

In an alternate embodiment, the digital monitoring system includes a distance or geographical sensor which determines information such as, but not limited to, the distance traveled by the walker in a certain amount of time and/or the user's geographical location. In one embodiment, the distance sensor is connected to at least one wheel of the walker. In this embodiment, the distance is determined by the rotation of the wheel. Distance sensors of this kind are known in the art. In an alternate embodiment, the distance or geographical sensor is GPS based and located in the housing. Distance and geographical sensors of this type are also known in the art.

In one embodiment, a biomedical or physiological response sensor measures a physical condition or body response, such as heart rate of the user and/or blood oxygen saturation levels. The biomedical response sensor may be mounted in the gripping surface (2) or hand grips. There are a variety of biomedical response sensors that are known to those of ordinary skill in the art. In one embodiment, the biomedical response sensor utilizes electrodes to detect the user's heart rate. In one embodiment, the biomedical response sensor measures the heart rate of the user by utilizing electrodes to detect the user's ECG signal. In a further embodiment, the electrodes are located in or on either the gripping surface (2) or the hand grips (2). In an alternate embodiment, the biomedical response sensor may be connected to the user's chest and/or wrist. Examples of biomedical response sensors are found in U.S. Pat. No. 6,304,774.

In an alternate embodiment, the digital monitor (30) may also include a calculating unit having a mathematical algorithm and a timer. In one embodiment, the calculating unit, mathematical algorithm and timer are incorporated in the CPU. In an alternate embodiment, the calculating unit, mathematical algorithm and timer are separate from the CPU. The mathematical algorithm is implemented by software that converts the exercise goal of the user to a caloric number based on known mathematical formulas. In an alternate embodiment, the mathematical algorithm also performs caloric expenditure calculations based on the measured heart rate and/or distance information received and the physiological parameters input by the user. Calculating units are known in the art. An example of a calculating unit is found in U.S. Pat. No. 6,605,044.

In one embodiment, the sensors described herein are connected to the microprocessor via communication lines. In another embodiment, the sensors are wirelessly connected to the microprocessor. Methods for connecting the sensors with wires and wirelessly are known to those of ordinary skill in the art.

The digital display (31) can be one of any assortment of displays known to those skilled in the art, such as, but not limited to, liquid crystal displays (LCDs) and light emitting diodes (LEDs). Additionally, the digital monitor may include buttons (32) or a touch-screen style digital display. Both of these displays are known to those skilled in the art.

The user interface includes control buttons (32) or touch screen features in order for a user of the system to access information within the system. In one embodiment, the user interface includes a start/stop button. In another embodiment, the user interface contains both a start/stop button and an on/off button. A user would press the start/stop button at the start of the activity and press the start/stop button again at the completion of the activity to cease the acquisition of data. A user would press the on/off button to activate the display so that a user can view recorded information on the display.

In one embodiment, the display is normally off and not drawing power from the associated power source. In such embodiment, the display is turned on only when a user activates the on/off button. In another embodiment, the display automatically turns off after a preselected time through the control of the microprocessor subsystem. In yet another embodiment, the display remains on until a user presses the on/off button again.

In one embodiment the user interface is voice activated. In another embodiment, the user can enter an exercise goal into the user interface. The exercise goal can be any exercise target that is convertible to calories, such as a caloric expenditure goal, a weight loss goal, a distance goal, or a time goal. In one embodiment, the user enters one or more physiological parameters into the user interface. These physiological parameters may include, but are not limited to, weight, height, age, sex, and self-reported exercise frequency and maximum heart rate. The exercise goal and physiological parameters can be entered manually by the user or wirelessly, or via a computer or Internet upload. Accordingly, the physiological parameters and the user's progress in reaching his or her goal may be remotely monitored, e.g., over the Internet, by someone other than the user, such as a trainer, coach, or healthcare professional. In one embodiment, the physiological parameters and exercise goals may be remotely modified by another party, such as a trainer, coach, or healthcare professional.

In one embodiment, the system calculates and stores successive records relating to quantified data. A user can access the successive records information by toggling a combination of buttons, which is known to those skilled in the art (e.g., a combination of holding one button down while pressing another button), or by including a separate button on the user interface. In another embodiment, the user can access the information through voice commands.

It should be clear to those skilled in the art that other buttons and/or combinations of buttons can be incorporated within the user interface and still be within the scope of the invention. The microprocessor subsystem stores much information and can be converted to different forms, e.g., averages, peaks, and totals. Different buttons and/or combinations of buttons can be used to access all of the available information.

In one embodiment, the microprocessor subsystem can include a microcontroller element, a microcontroller element with reduced functionality to reserve power, or a microprocessor element with associated memory and logic to perform the requisite calculations, including the processing power to drive the display and user interface.

In another embodiment, the microprocessor subsystem is constructed by several components. The microprocessor subsystem includes a central processing unit (CPU), memory, interface electronics, and conditioning electronics. The user interface, including the button inputs, connects to the subsystems and the conditioning electronics. The display connects to the subsystem and directly to the CPU.

While several descriptions of walkers are included in this patent, it will be obvious to those skilled in the art that any design or style of walker may be used and still fall within the claims. Additionally, while several descriptions of digital monitors and digital displays are described herein, it will be understood that any design of digital monitor and digital display that monitors and displays biological or physiological data from the user and/or geographic information may be used and still fall within the claims.

Any and all references to patents, documents, and other writings contained herein shall not be construed as an admission as to their status with respect to being or not being prior art.

There are other alternate embodiments that are obvious from the foregoing descriptions and which are intended to be included within the scope of the invention, as defined by the following claims.

1. A walker comprising:
a. a frame;
b. at least three legs located on said frame; and
c. a digital monitor mounted to said frame, said digital monitor comprising at least one sensor and a user interface, said user interface comprising a digital display.

2. The walker of claim 1, wherein said sensor comprises a biological sensor.

3. The walker of claim 1, wherein said sensor comprises a geographical sensor.

4. The walker of claim 1, wherein said sensor comprises a distance sensor.

5. The walker of claim 1, wherein said sensor comprises a speed sensor.

6. The walker of claim 1, wherein there are a plurality of sensors.

7. The walker of claim 6, wherein said plurality of sensors comprises a biological sensor, a geographical sensor, and a speed sensor.

8. The walker of claim 1, wherein the digital display comprises buttons for controlling said digital display.

9. The walker of claim 1, wherein the digital display is voice activated and voice controlled.

10. The walker of claim 1, wherein the digital display comprises a touch screen for controlling said digital display.

11. A walker comprising:
a. a frame;
b. at least three legs located on said frame;
c. a digital monitor mounted to said frame, said digital monitor comprising at least one sensor and a user interface, said user interface comprising a digital display; and
d. a means for mounting said digital monitoring device to said frame.
